(19) United States
(12) Patent Application Publication
(10) Pub. No.: US 2003/0222895 A1
(43) Pub. Date: Dec. 4, 2003

(54) Image display apparatus and control method for image display apparatus

(75) Inventor: Yutaka Arai, Atsugi-shi (JP)

Correspondence Address: SCULLY SCOTT MURPHY & PRESSER, PC, 400 GARDEN CITY PLAZA, GARDEN CITY, NY, 11530

(73) Assignee: NEC-MITSUBISHI ELECTRIC VISUAL SYSTEMS CORPORATION, TOKYO (JP)

(21) Appl. No.: 10/452,328

(22) Filed: May 30, 2003

(30) Foreign Application Priority Data
Jun. 3, 2002 (JP) 2002-161598

(51) Int. Cl. G09G 5/02

(52) U.S. Cl. 345/698

(57) ABSTRACT

An image signal generating device 14 of an image signal generator 11 is connected to an image display apparatus 12 with a maximum resolution of SXGA (1280×1024), and to an image display apparatus 13 with a maximum resolution of XGA (1024×768). The resolution of the image signal which the image signal generator 11 generates is set so as to be the same as the resolution of the image display apparatus 12 which can display the highest resolution, amongst all of the image display apparatuses 12 and 13 which are connected. Moreover, in the case where the image display apparatus 13 for which the resolution which can be displayed is low is included within the image display system, the image signal generator 11 outputs as the net image signal, an image signal only for the range of the resolution which can be displayed, for the page which is to be displayed on this image display apparatus 13.

### BACKGROUND OF THE INVENTION

1. Field of the Invention

The present invention relates to an image display apparatus and a control method for an image display apparatus, for receiving from an image signal generator, an image signal having a predetermined format used for example in a personal computer (hereunder referred to as a PC), and displaying the image signal on a display device such as a liquid crystal, a CRT, a plasma display (PDP) or an electroluminescence (EL) display.

2. Description of the Related Art

FIG. 14 is a block diagram showing an image display system according to a conventional example. That is, this figure is a block diagram of an image display system disclosed in Japanese Unexamined Patent Application, First Publication No. 2000-352962, comprising an image signal generator and an image display apparatus for the case where indexing is used. In FIG. 14, this image display system comprises an image signal generator 141, a plurality of image display apparatuses 142, and an image signal generating device 143. Furthermore, FIG. 15 and FIG. 16 are diagrams showing the relationship between an image signal and an index in the conventional image display system disclosed in Japanese Unexamined Patent Application, First Publication No. 2000-352962.

Next is a description of the operation of the image display system shown in FIG. 14. As shown in FIG. 14, in the proposal of Japanese Unexamined Patent Application, First Publication No. 2000-352962, with respect to the image signal generator 141 including one image signal generating device 143, a plurality of image display apparatuses 142 can be connected in parallel by means of a connection cable or the like, so that different images can be displayed on each of the image display apparatuses 142. More specifically, the image signal generator 141 has a plurality of pages thereinside, and the image signal generating device 143 generates a composite signal containing index signals allotted to each of the pages as per the relationship diagram of image signals and indexes shown in FIG. 15, and the image display apparatuses 142 judge from these index signals whether or not the signal is for the image display apparatuses to perform display. This composite signal is divided timewise for each page as shown in FIG. 16 and transmitted. Moreover, each of the image display apparatuses 142 have one display apparatus number differing each other so that different displays can be performed for each of the image display apparatuses 142.

Furthermore, in the technique of the disclosure of Japanese Unexamined Patent Application, First Publication No. 2000-352962, it is also possible as with the system concept diagram for the image display apparatus shown in FIG. 17, to have a construction where a plurality of image display apparatuses 142 are series connected to one image signal generator 141. In this case, the image display apparatuses 142 can display different images. More specifically, in contrast to the image display apparatuses 142 shown in FIG. 14 connected in parallel, in the image display apparatuses 142 shown in FIG. 17, by providing image output devices inside each of these, these can display images one by one, while sequentially transmitting the received image signals to the next stage image display apparatus 142. At this time, by setting different image display apparatus numbers for each of the image display apparatuses 142, different images can be displayed on the respective image display apparatuses 142.

In the parallel connected image display apparatuses 142 shown in FIG. 14 and the series connected image display apparatuses 142 shown in FIG. 17, there is only one image signal generating device 143. Therefore, in the case where the some of the connected plurality of image display apparatuses 142 have different resolutions or have a frequency restriction, it is necessary to switch to and output an image signal having the different resolution or frequency for each of the respective image display apparatuses. However, since the image signal generating device 143 cannot perform this switching in a short time, a large amount of time is necessary for page switching, and in the case where a plurality of image display apparatuses are used at the same time, there is the disadvantage that updating of the images is delayed. Moreover, in the case where an analog signal is used for the image signal, a large amount of time is necessary to stabilize the PLL (phase locked loop) circuit for reproducing the image signal clock contained in the image display apparatus. Therefore, even if the image signal generator has a plurality of image signal generating devices, it takes time to update the image.

The present invention addresses the above mentioned problems, with the object of providing an image display apparatus which performs page switching at high speed by not performing switching of the resolution even if image display apparatuses with different resolutions exist together. That is to say, in the conventional multi-monitor system of the index type as shown in the Japanese Unexamined Patent Application, First Publication No. 2000-352962, by not performing switching of the image output resolutions in the image signal generators even if image display apparatuses with different required resolutions exist together, page switching can be performed at high speed. Furthermore, it is an object to obtain an image display apparatus which provides a comfortable user environment for the user. Moreover, it is an object to provide a control method appropriate for this image display apparatus.

### SUMMARY OF THE INVENTION

In order to achieve the above mentioned objects, an image display apparatus of the present invention is one where an image display apparatus for receiving an image signal having a predetermined format and displaying that image signal, comprises: an image signal receiving section which receives a composite image signal containing an image signal comprising a plurality of image frames, a synchronization signal corresponding to the image signal, and a transmission index signal substituted for one part of the image signal, and outputs the image signal and the synchronization signal; an image frame selection section which multiply selects image frames to be displayed on the image display apparatus from the plurality of image frames, based on the transmission index signal output from the image signal receiving section, and extracts and outputs image signals of a resolution which can be displayed on the image display apparatus from the selected image signals; and an image display section which displays an image signal which is output from the image frame selection section.

Moreover, in the image display apparatus of this invention, the image frame selection section comprises: an index discriminating device which discriminates a transmission index signal contained in either of an image display period or an image non-display period in an image frame, based on the image signal and the synchronization signal output from the image signal receiving section; an image display apparatus number setting device which outputs an image display apparatus number set with respect to the image display apparatus; an index judgment device which outputs a frame selection signal for selecting an image frame contained in an image signal, based on an index signal output by the index discriminating device and an image display apparatus number of the image display apparatus output by the image display apparatus number setting device; a frame selection device which selects an image frame contained in the image signal corresponding to a frame selection signal output from the index judgment device; an image extraction device which extracts an image signal corresponding to the image frame output from the frame selection device, as data for the maximum resolution amount which can be displayed in the image display section of the image display apparatus, and an image storage device which stores image signals which the image extraction device has extracted and output.

Moreover, in the image display apparatus of this invention, the image frame selection section comprises: an index discriminating device which discriminates a transmission index signal contained in either of an image display period or an image non-display period in an image frame, based on the image signal and the synchronization signal output from the image signal receiving section; an image display apparatus number setting device which outputs an image display apparatus number set with respect to the image display apparatus; an index judgment device which outputs a frame selection signal for selecting the image frame contained in an image signal, based on an index signal output by the index discriminating device and an image display apparatus number of the image display apparatus output by said image display apparatus number setting device; a frame selection device which selects an image frame contained in the image signal corresponding to a frame selection signal output from the index judgment device; an image compression device which compresses signals so that an image signal corresponding to an image frame output from the frame selection device can be the maximum resolution which the image display section of the image display apparatus can display; and an image storage device which stores image signals which the image compression device has compressed and output.

Furthermore, in the image display apparatus of this invention, the image frame selection section comprises: an index discriminating device which discriminates a transmission index signal contained in either of an image display period or an image non-display period in the image frame, based on the image signal and the synchronization signal output from the image signal receiving section; an image display apparatus number setting device which outputs an image display apparatus number set with respect to the image display apparatus; an index judgment device which outputs a frame selection signal for selecting the image frame contained in an image signal, based on an index signal output by the index discriminating device and an image display apparatus number of the image display apparatus output by the image display apparatus number setting device; a frame selection device which selects an image frame contained in the image signal corresponding to a frame selection signal output from the index judgment device; an image expansion device which expands signals so that an image signal corresponding to an image frame output from the frame selection device can be the maximum resolution which the image display section of the image display apparatus can display, and an image storage device which stores image signals which the image expansion device has expanded and output.

Moreover, in the image display apparatus of this invention, the image frame selection section further comprises a communication device which communicatively connects the image display apparatus number setting device and the image extraction device.

Furthermore, a control method for an image display apparatus according to this invention for receiving an image signal having a predetermined format and displaying the image signal on an image display apparatus, comprises the steps of; controlling an extraction position of the image signal based on a control signal contained in a transmission index signal, and displaying a desired image on the image display apparatus.

According to this configuration, the image display apparatus can select the frame from amongst the received image signals, and extract and display only the range for which the image display apparatus can display. Consequently, even in the case where image display apparatuses having different maximum resolutions exist together within the image display system, different image displays can be executed with respect to a plurality of image display apparatuses, using a single image signal generating device.

Moreover the communication device is provided, and the maximum resolution which can be displayed by the image display device of the image display apparatus which is set in the image extraction device is read out, and this information is transmitted to the image signal generator. As a result, the operator can omit the time for setting the image display apparatus number for each of the respective image apparatuses and also can omit the time for setting the output resolutions which match with this image display apparatus. Hence a more agreeable image display apparatus use environment can be provided.

Furthermore, even though the image display apparatuses connected inside the image display system have different maximum resolutions, an image display apparatus with a lower maximum resolution than that of the image display apparatuses connected inside the image display system, performs display for a screen where this is compressed to the maximum resolution which the image display apparatus can display. Therefore, the common image signal generators no longer need to set the resolution which is output for each of the pages, to match the resolution of the respective image display apparatuses. As a result, the time and effort necessary for resetting the output resolution, or the time etc. required for switching can be saved, enabling construction of a more effective image display system.

Moreover, even though the image display apparatuses connected within the image display system have different maximum resolutions, an image display apparatus for which the maximum resolution is lower than that of the image display apparatuses connected within the image display system compresses the image to the maximum resolution which the image display apparatus can display and automatically displays the image. Consequently, the image signal generator and the image display apparatus no longer need to set the resolution which is output for each of the pages, to match the respective resolutions. As a result, the time and effort necessary for resetting the output resolutions, or the time etc. required for switching screens can be saved, enabling construction of a more effective image display system.

Furthermore, even though the plurality of image display apparatuses connected inside the image display system have different maximum resolutions, an image display apparatus for which the maximum resolution which can be displayed on the image display apparatus is higher than the lowest resolution amongst the maximum resolutions of the image display apparatuses connected inside the image display system, is able to expand the image signal and effect display the image. Therefore, the image signal generator no longer needs to set the resolution which is output for each of the pages, to match the respective resolutions. As a result, the time and effort necessary for resetting the output resolutions, or the time etc. required for switching can be saved, enabling construction of a more effective image display system.

Moreover, information can be received and transferred between the image signal generator and the image display apparatus without providing a special communication device or connection cable. Furthermore, since this information can include information of the image extraction position, the position for the image to be displayed can be automatically set. As a result, even in the case where there are image display apparatuses with different resolutions within the image display system, the image display apparatus can be used without the operator being aware of this.

### BRIEF DESCRIPTION OF THE DRAWINGS

FIG. 1 is a block diagram schematically showing an image display system according to a first embodiment of the present invention.

FIG. 2 is a block diagram showing a configuration of an image display apparatus according to the first embodiment of the present invention.

FIG. 3 is a timing chart showing a relationship between image signal and index in the first embodiment of the present invention.

FIG. 4 is a timing chart showing a relationship between image signal and index in the case of a plurality of pages in the first embodiment of the present invention.

FIG. 5 is a time chart showing a configuration of an image signal in the case where the maximum resolutions of image display apparatuses included in an image display system are different, in the first embodiment of the present invention

FIG. 6 is an explanatory diagram showing a specific example of where a transmission index signal substituted for one part of an image signal is shown by flags, in the first embodiment of the present invention.

FIG. 7 is a diagram showing a relationship between the index ID indicated by a flag and the image display apparatus number for selecting a frame, in the first embodiment of the present invention.

FIG. 8 is a block diagram showing a configuration of an image display apparatus in a second embodiment of the present invention.

FIG. 9 is a block diagram showing a configuration of an image display apparatus in a third embodiment of the present invention.

FIG. 10 is a block diagram showing a configuration of an image display apparatus in a fourth embodiment of the present invention.

FIG. 11 is a block diagram showing a configuration of an image display apparatus in a fifth embodiment of the present invention.

FIG. 12 is a block diagram showing a configuration of an image display apparatus in a sixth embodiment of the present invention.

FIG. 13 is a diagram showing, by means of flags, a configuration of a transmission index in the sixth embodiment of the present invention.

FIG. 14 is a block diagram showing an image display system according to a conventional example.

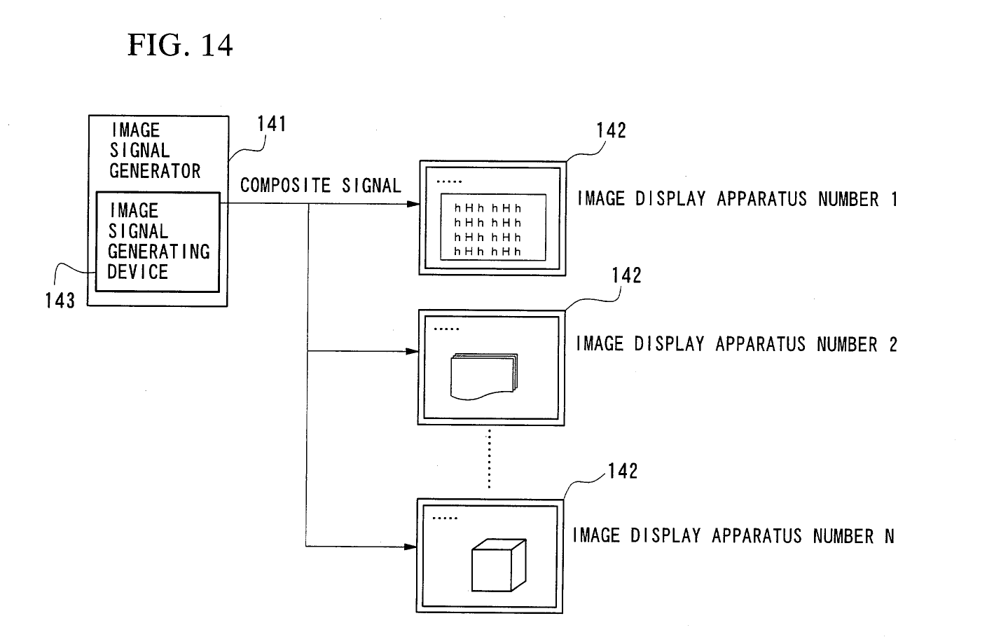

FIG. 15 is a timing chart showing image signals and indexes according to the conventional example.

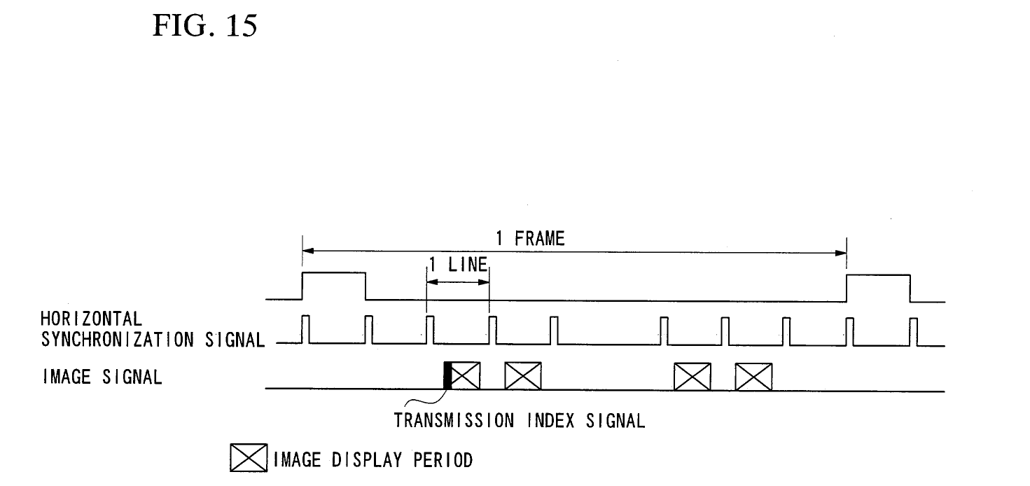

FIG. 16 is a timing chart showing image signals and indexes according to the conventional example.

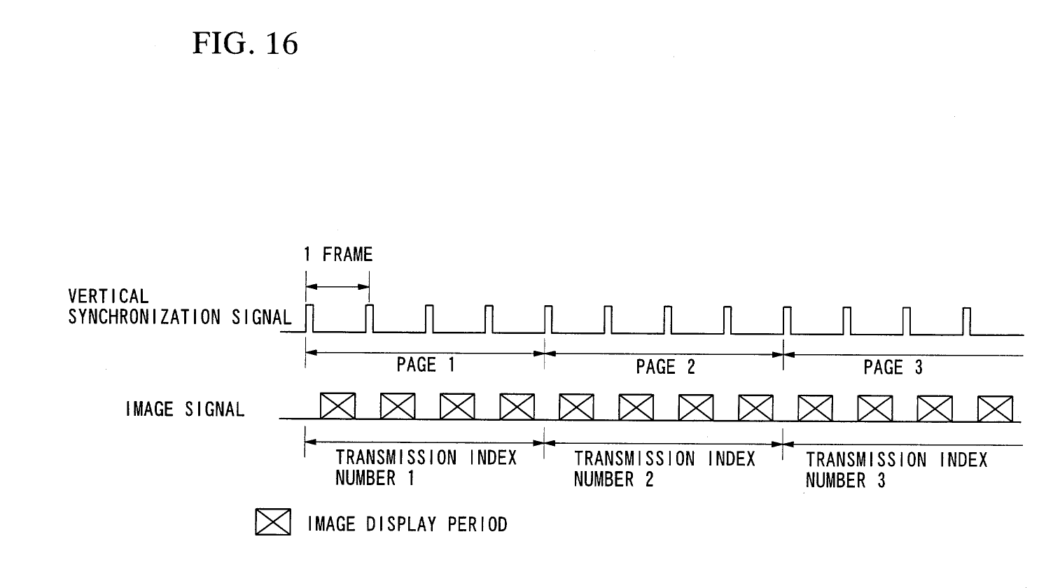

FIG. 17 is a block diagram showing an image display system according to another conventional example.

### DESCRIPTION OF THE PREFERRED EMBODIMENTS

Hereunder is a detailed description of several embodiments of an image display apparatus according to the present invention, with reference to the drawings.

### First Embodiment

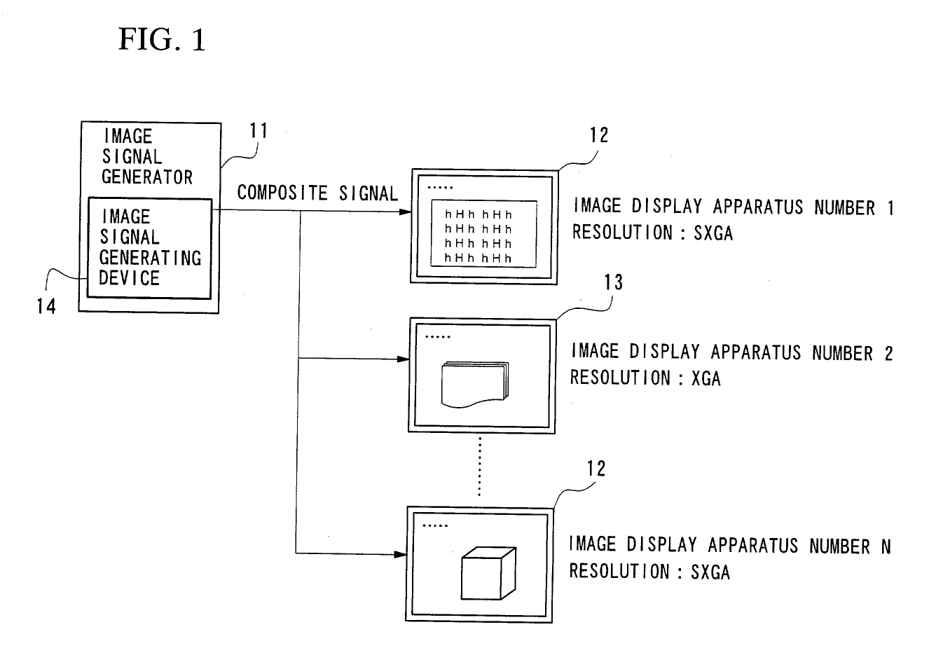

FIG. 1 is a block diagram schematically showing an image display system according to a first embodiment of the present invention. In FIG. 1, this image display system comprises; an image signal generator 11, an image signal generating device 14, an image display apparatus 12 having a maximum resolution of SXGA, and an image display apparatus 13 having a maximum resolution of XGA. Here, as shown in the figure, the plurality of image display apparatuses 12 and 13 are set with image display apparatus numbers 1-n, and are connected electrically to the image signal generator 11 by a connection cable or the like.

Hereunder is a description of the operation of the image display system. The image signal generator 11 outputs a net image signal which is to be actually displayed to an image display section (for example a liquid crystal panel, a CRT, a PDP, an EL, etc.) of the image display apparatuses 12 and 13, a synchronization signal corresponding to this net image signal, and a transmission index signal substituted for one part of the net image signal (hereunder these output signals are generally referred to as a composite signal). In this composite signal, most basically, an original frame is constructed from the net image signal and the synchronization signal, but a frame (also referred to as an image frame) containing a transmission index signal is further constructed in this original frame.

At this time, the resolution of the image signal which the image signal generator 11 generates is set so as to be the same as the resolution of the image display apparatus which can display the highest resolution, amongst all of the image display apparatuses 12 and 13 which are connected. Moreover, in the case where an image display apparatus for which the resolution which can be displayed is low is included within the image display system, the image signal generator 11 outputs as the net image signal, an image signal only for the range of the resolution which can be displayed, for the page which is to be displayed on this image display apparatus. More specifically, in the case where the maximum resolution which the image display apparatus 12 within the image display system can display is SXGA (1280×1024), then in the frame which is to be displayed in the image display apparatus 13 with a maximum resolution of XGA (1024×768), a format having a composite signal remains as the SXGA signal, and only the image signal is limited to the range of 1024×768 from the top left of the image region of the image signal, and output.

Moreover, the image display apparatus number from the image signal side is used for specifying the net image signal, in the frame constituting the composite signal, to be displayed by one of the image display apparatuses 12 and 13, which are shown in FIG. 1, which respectively have the image display apparatus number. Proceeding with the explanation, apart from specifying the image display apparatuses 12 and 13, comment is also given on the transmission index signal for the case where various information is appended. A proviso is that at least information related to the image display apparatus number is included.

The composite signal output from the image signal generator 11 is applied in parallel to the respective image display apparatuses 12 and 13. In other words, composite signals having the same contents are respectively applied to the image display apparatuses 12 and 13. In each of the image display apparatuses 12 and 13, basically, the respective signals of the net image signal, the synchronization signal and the transmission index signal are separated from the received composite signal. Then, regarding the image display apparatuses 12 and 13, in the image display apparatus for which the set image display apparatus number and the transmission index signal are compatible, the net image signal contained in the frame having the image display apparatus number from this image signal side is displayed on the image display section of the image display apparatuses 12 and 13.

In the above described example, the image display apparatus number set in the image display apparatuses 12 and 13 may exist in duplicate. In this case, then naturally there will be the same display in the image display apparatuses set with the same image display apparatus number. In the case where the transmission index signal is substituted in the net image signal and output from the image signal generator 11, then within the display image in the image display apparatuses 12 and 13, the display content shown as the index such as shown in FIG. 1 is displayed together with the display content in the net image signal.

Regarding the image display apparatus 12 which has the maximum resolution within the image display system of the first embodiment, since this is the same as the apparatus described in detail in the Japanese Unexamined Patent Application, First Publication No. 2000-352962, description is here omitted. Consequently, concerning the image display apparatus 13 having a resolution which does not satisfy the maximum resolution within the image display system, description is given for the control method for an image display apparatus, from reception of the image signal up until display of the image.

That is to say, in a first step, a composite signal containing a transmission index signal substituted for one part of the image signal in an arbitrary image frame of an image signal comprising a plurality of image frames is received. Next, in a second step, an image frame which is to be displayed on the image display apparatus is selected from a plurality of image frames, based on the transmission index signal contained in the received composite signal, and from the selected image frame, the image signal corresponding to the resolution which the image display apparatus can display is stored.

In the second step, while described in detail later, there is included respective steps from (a) to (d) as described hereunder. At first, (a) the transmission index signal is discriminated from the composite signal and an index signal is output. (b) a frame selection signal is output based on the output index signal and an image display apparatus number set for the image display apparatus. (c) the image frame contained in the image signal corresponding to the output frame selection signal is selected. (d) the selected image signal is extracted to match with the maximum resolution which the image display apparatus can display, and stored.

Then, after matching and extracting the image signal selected in the second step with the maximum resolution which the image display apparatus displays and storing, in the third step, the stored image signal is displayed as the image on the image display section.

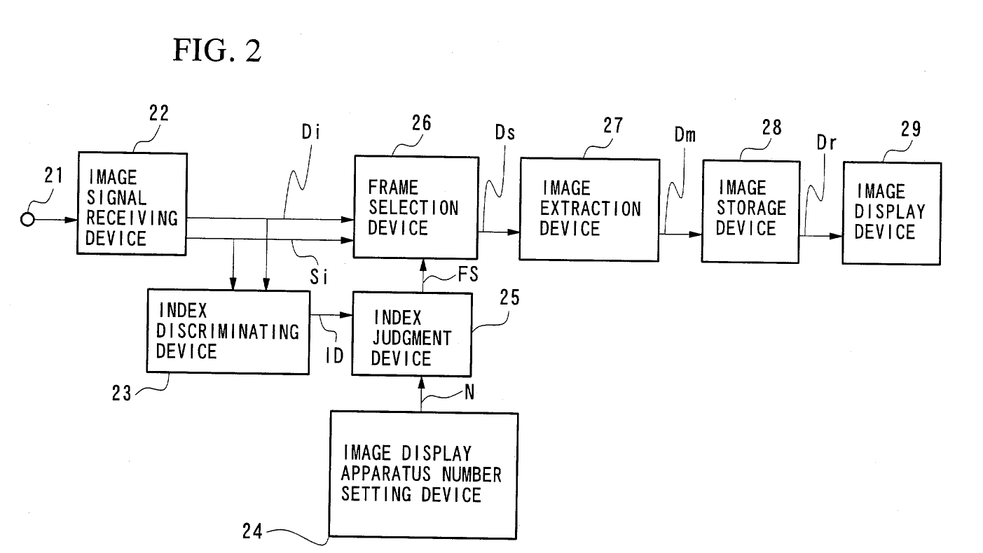

Hereunder is a more detailed description of the first embodiment with reference to the drawings. FIG. 2 is block diagram showing the internal structure of the image display apparatus 13 shown in FIG. 1. As shown in FIG. 2, the image display apparatus comprises; an image signal input terminal 21, an image signal receiving device 22, an index discriminating device 23, an image display apparatus number setting device 24, an index judgment device 25, a frame selection device 26, an image extraction device 27, an image storage device 28, and an image display device 29.

Moreover, Di is an image signal output from the image signal receiving device 22, Ds is an image signal which the frame selection device 26 outputs, Dm is an image signal which the image extraction device 27 outputs, Dr is an image signal which the image storage device 28 outputs, Si is a synchronization signal which the image signal receiving device 22 outputs, ID is an index which is discriminated by the index discriminating device 23, N is an image display apparatus number set by the image display apparatus number setting device 24, and FS is a frame selection signal which the index judgment device 25 outputs.

In the description of the various embodiments shown hereunder, while not particularly limiting, the image signal receiving device 22 constitutes the image signal receiving section, the index discriminating device 23, the image display apparatus number setting device 24, the index judgment device 25, the frame selection device 26, the image extraction device 27, and the image storage device 28 constitute the image frame selection section, and the image display device 29 constitutes the image display section.

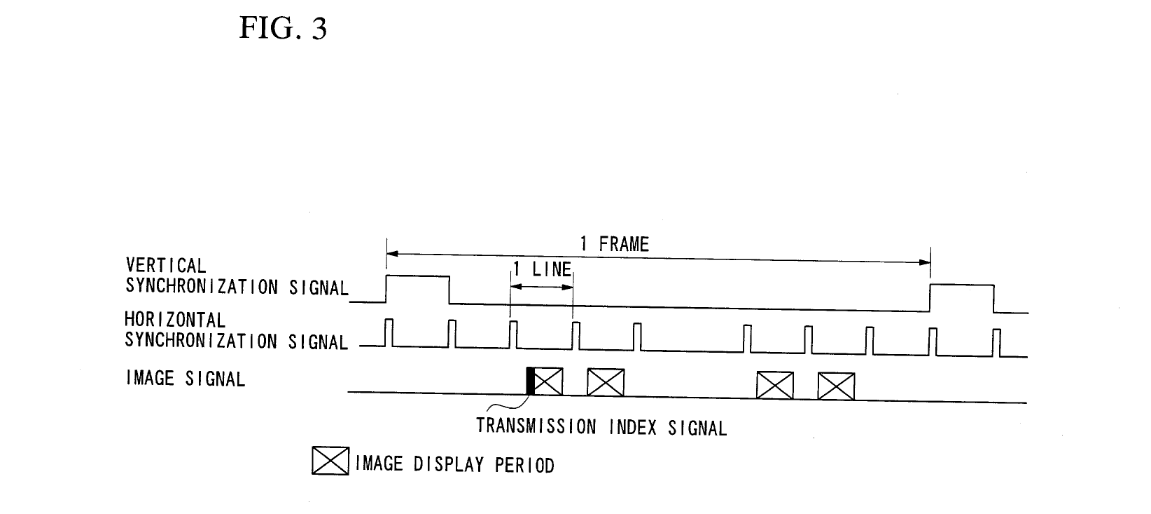

Next is a description of the operation of the image display apparatus shown in FIG. 1 and FIG. 2. Here the image signal receiving section (image signal receiving device 22) and the image display section (image display device 29) are the same as those disclosed in Japanese Unexamined Patent Application, First Publication No. 2000-352962, and hence description is omitted hereunder, while description is given of the image frame section. FIG. 3 is a relationship diagram of the image signal and the transmission index signal, for explaining the case where the transmission index signal is substituted for one part of the image signal in the image display period within the image signal. The horizontal axis represents time and the vertical axis represents voltage. As will be understood by referring to FIG. 3, the relationship of the respective timings of the vertical synchronization signal, the horizontal synchronization signal and the image signal in a single frame period is shown.

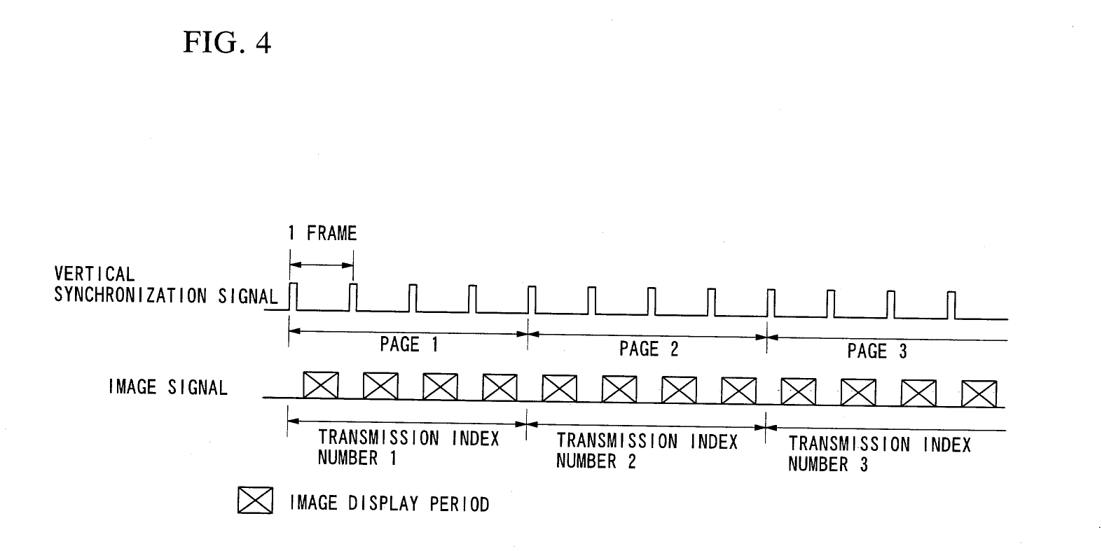

FIG. 4 is a relationship diagram of the image signal and the transmission index signal, for explaining a relationship of the timing of an image signal of a plurality of pages and a transmission index signal substituted for one part of the image signal, which the image signal generating device 14 shown in FIG. 1 outputs. In FIG. 4, the horizontal axis represents time and the vertical axis represents voltage. Moreover, page referred to here, as will be understood with reference to FIG. 4, is a page comprising one or more timewise consecutive frames. Furthermore, the definition of page includes the meaning of one section (that is a section where one display screen is constituted by one or a plurality of regions) for the case where one display screen is divided into one or a plurality of regions, or one type of display screen in a plurality of types of display screens for which the contents are basically each different in different pages.

In FIG. 4, to simplify understanding, the transmission index signal corresponding to page 1 corresponds to index 1, the transmission index signal corresponding to page 2 corresponds to index 2, and the transmission index signal corresponding to page 3 corresponds to index 3. Here, the image signal generator 11 switches over the page after the one frame where the transmission index signal is changed as shown in the figure.

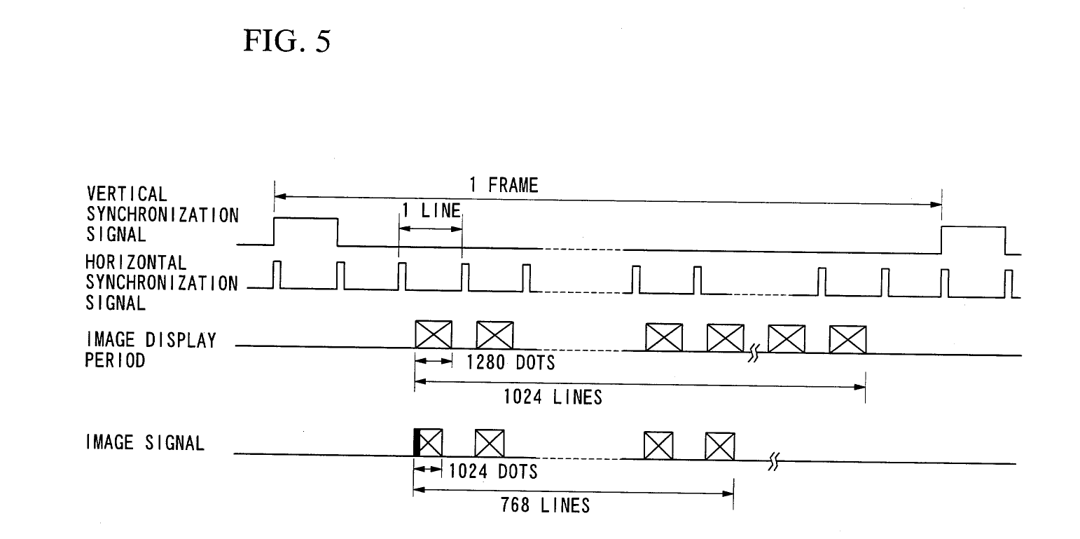

FIG. 5 is a time chart showing a configuration of an image signal in the case where the maximum resolutions of image display apparatuses included in an image display system are different, in the first embodiment of the present invention. That is to say, in FIG. 5, the maximum resolution of the image display apparatuses included in the image display system is SXGA, and the configuration of the image signal is conceptually shown for the case where the image display apparatus which is to display the frame shown here has a maximum resolution for XGA. In this figure, supposing that page 2 is the page which is to be displayed on the image display apparatus 13 having a maximum resolution which is lower than the maximum resolution within the image system, then regarding the signal of the frame corresponding to page 2, as shown in FIG. 5, the image display period is held at 1280 dots×1024 lines, but the net image signal is limited to 1024 dots×768 lines.

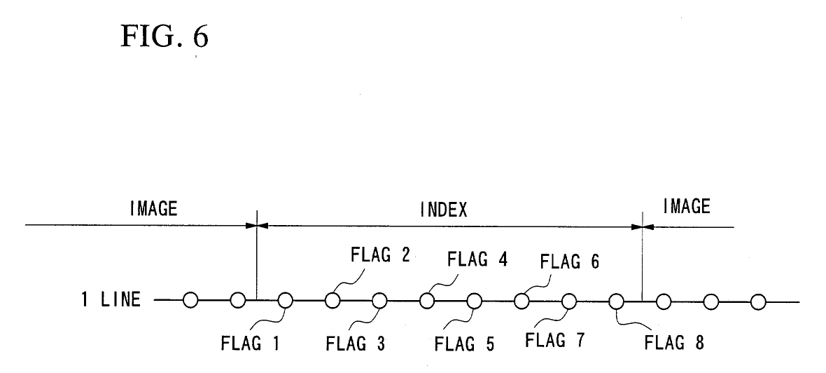

FIG. 6 is an explanatory diagram showing a specific example with the transmission index signal substituted for one part of the image signal shown by a flag, and showing one part of one line in the image signal corresponding to one line on the display image. In FIG. 6, the circle flags represent one pixel. The transmission index signal comprises for example 8 pixels at predetermined positions (here on one line on the display screen) of an image period. A desired lighting (brightness) is set for the respective pixels which constitute the transmission index signal. Based on this lighting (brightness), the image signal generator 11 generates a flag corresponding to the image display apparatus number. A detailed description of this is given later.

Hereunder is a description of the operation of the image display apparatus with reference to the drawings. As shown in FIG. 1 and FIG. 2, the composite signal input to the image signal input terminal 21 of the image display apparatuses 12 and 13 is received by the image signal receiving device 22. The image signal receiving device 22, as described in Japanese Unexamined Patent Application, First Publication No. 2000-352962, outputs a synchronization signal Si and an image signal Di which has been digitized. In this case, the transmission index is substituted within the image signal Di and digitized.

The synchronization signal Si and the image signal Di output from the image signal receiving device 22 are input to the frame selection device 26 and the index discriminating device 23 shown in FIG. 2. The index discriminating device 23 computes the position within the image signal, of the transmission index signal which is constituted by the light and shade of the pixel shown in FIG. 6, with the synchronization signal Si as a reference for the timing (datum reference on the time axis), and extracts the received transmission index signal.

The transmission index signal, from a noise tolerance point of view, is more simply expressed by a combination of gradations of the maximum value or the minimum value of half-toning (that is, the 255th gradation or the 0th gradation in 256 half-toning). In the following description, for simplicity, the transmission index signal is constituted by combining the maximum values or the minimum values of the half-toning.

The received transmission index signal is binarized in the index discriminating device 23 based on a previously set threshold value. As one example of this threshold value, the 128th gradation being the gradation of half the 256 gradations is adopted as the threshold value. In this case, for example this is applied as a flag which becomes “1” when the gradations are from 255 gradations to 129 gradations, and becomes “0” when the gradations are from 0 gradations to 128 gradations, and the index ID is constructed by combining these flags.

The index discriminating device 23 outputs the index ID obtained in the abovementioned manner to the index judgment device 25. On the other hand, the image display apparatus number setting device 24 outputs the image display apparatus number N previously set for the image display apparatus to the index judgment device 25. In this image display apparatus number N, for example a plurality of combinations of “1” or “0” are set by hardware settable dip switches.

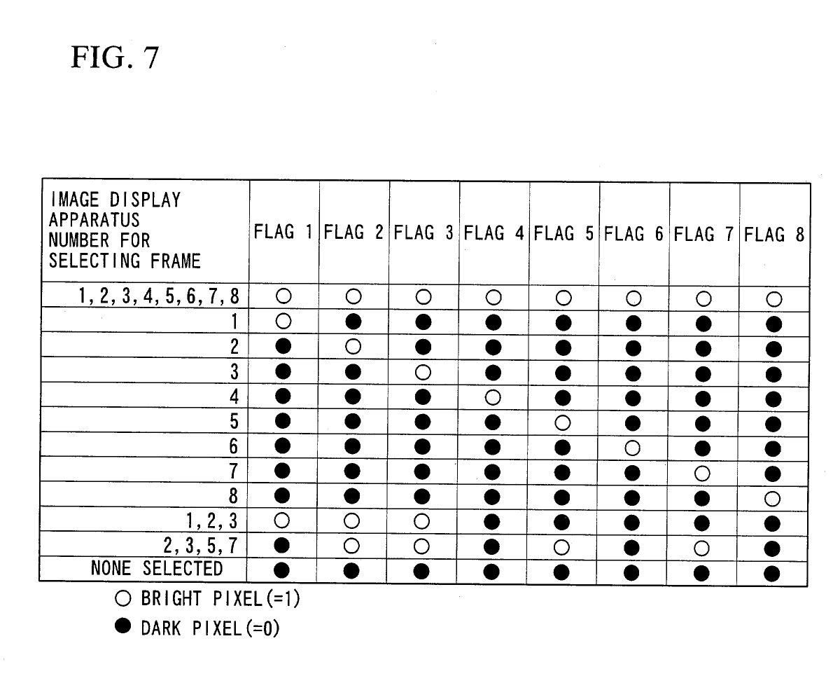

The index judgment device 25 outputs the frame selection signal FS based on the discriminated index ID and the image display apparatus number N. FIG. 7 shows the relationship of the index ID expressed by the flags and the image display apparatus number for selecting the frame. In FIG. 7, the white circles show the flags corresponding to bright pixels, and the black circles show the flags corresponding to dark pixels. As described above, an 8 bit flag is generated by binarizing the transmission index signal in the index discriminating device 23 (that is, corresponding to the transmission index signal shown in FIG. 6). Here since the index ID comprises an 8 bit flag, then at maximum the case of 256 (display modes) can be specified. In this case, the number of numbers for the controllable image display apparatus coincides with the number of bits of the index ID.

As will be understood with reference to FIG. 7, in the case where all of the flags are “1”, then in both image display apparatuses 12 and 13, a frame having a transmission index signal such that all of the flags become “1” is selected. That is, in all cases no matter how the image display apparatus number is set, an image signal for the selected frame is output. In other words, the frame for the image display apparatus number which the flag “1” stands for is selected.

Moreover, in the case where the flag 1 is “1”, then in the case where a “1” is set for the image display apparatus number N, a frame such that the flag 1 generated from the transmission index signal becomes “1” is selected, while in the case where the flag 2 is “1”, a frame such that the flag 2 generated from the transmission index signal in the case where a “2” is set for the image display apparatus number N becomes “1”, is selected. In this manner, in the case where the mth flag in the index ID is “1”, a frame such that the mth flag generated from the transmission index signal in the image display apparatus 12 with an “m” set for the image display apparatus number N becomes “1”, is selected. At this time, there may be a plurality of image display apparatuses with m set for the image display apparatus number N. Furthermore, by having a certain frame such that a plurality of flags for the frame become “1”, it is also possible to select frames in a plurality of image display apparatuses set with different image display apparatus numbers N.

The frame selection device 26 selects a designated frame from the input image signal Di, based on the frame selection signal FS which the index judgment device 25 has output. Here since the transmission index signal is substituted for one part of the image period, then the actually selected frame is the frame after one frame. The image signal Ds selected by the frame selection device 26 is input to the image extraction device 27 shown in FIG. 2. The image extraction device 27 extracts from the image signal Ds which the frame selection device 26 has selected, the image data for the previously set maximum resolution portion which the image display device 29 of the image display apparatus can display.

Here in the image display apparatus 13, the maximum resolution is not satisfied for the maximum resolution (1280 dots×1024 lines) of the image display system. Consequently, the image signal of the image frame for which the image display apparatus number N set in the image display apparatus 13 becomes the transmission index number, becomes as shown in FIG. 5, an image signal of a range capable of display, with the net image signal smaller than the image display area. In the example of FIG. 5, the case is shown where the maximum resolution of the image display system is 1280 dots×1024 lines, and the maximum resolution capable of display by the image display apparatus is 1024 dots×768 lines.

The image extraction device 27 outputs the extracted image signal Dm to the image storage device 28. As a result, the image storage device 28 receives and stores the image signal Dm output from the image extraction device 27. Furthermore, the image storage device 28 reads out the stored image data and converts this to an image signal Dr of a format which can be displayed by the image display device 29. Then, the image display device 29 receives the image signal Dr output from the image storage device 28 and displays the image. In the above description, the description was given for the case where the transmission index signal was substituted for the image signal in the period during the image period. However the configuration of the other transmission index signals is as in the disclosure in Japanese Unexamined Patent Application, First Publication No. 2000-352962, and here description is omitted.

Furthermore, in the above example, the description was given for the case where the image display apparatuses were connected in parallel. However by providing an image signal output device in the above mentioned configuration, it is also possible to connect the image display apparatuses 13 in series. The differences between the configuration and operation for this case and the above mentioned configuration and operation, is given in detail in the disclosure of Japanese Unexamined Patent Application, First Publication No. 2000-352962. Therefore description is here omitted. Furthermore, in the above description, the description was given for where the image extraction was carried out in sequence from the first of the image data. However in the case where the image extraction position is separately set, then image extraction for an arbitrary range can be performed.

According to the configuration of the image display apparatus of the first embodiment, the image display apparatus 13 can select the frame from amongst the received image signals, and extract and display only the range for which the image display apparatus can display. Consequently, even in the case where as shown in FIG. 1, image display apparatuses having different maximum resolutions exist together within the image display system, different image displays can be executed with respect to a plurality of image display apparatuses, using a single image signal generating device 14.

### Second Embodiment

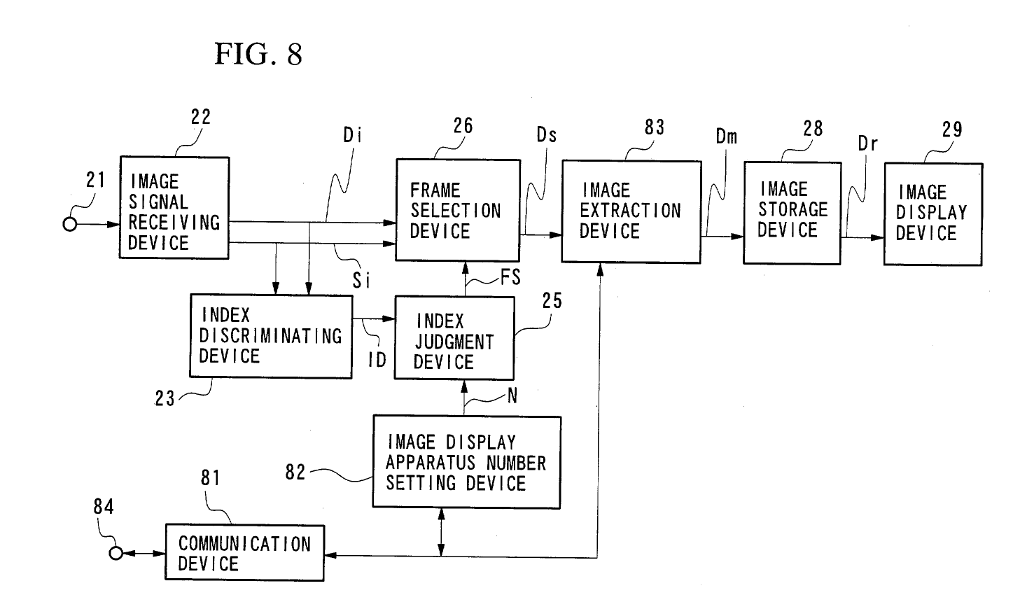

FIG. 8 is a block diagram showing a configuration of an image display apparatus 13 in a second embodiment of this invention. In FIG. 8, the image display apparatus 13 comprises: an image signal input terminal 21, an image signal receiving device 22, an index discriminating device 23, an image display apparatus number setting device 82, an index judgment device 25, a frame selection device 26, an image extraction device 83 an image storage device 28, an image display device 29 and a communication device 81. The image display apparatus number setting device 82 and the image extraction device 83 have a different signal input and output function to in the first embodiment shown in FIG. 2, and hence the symbols therefor are changed. Moreover, 84 denotes a connecting terminal for the communication device 81. Hereunder description is omitted for parts which duplicate those of the first embodiment.

In the description of the operation according to the configuration of the first embodiment, the image display apparatus number N of the image display apparatus 13 was set to an arbitrary value by the image display apparatus number setting device 24. Moreover, the resolution of the image signal output by the image signal generating device 14 was also arbitrarily set.

On the other hand, the operation of the second embodiment is as follows. The communication device 81 is connected to the image signal generator 11 of FIG. 1 via the connecting terminal 84. For this connection, in general an electrical connection device such as a connection cable is used. In general, the image signal generator 11 uses a personal computer (PC) or the like, and for the communication method, it is assumed that a two way communication interface such as a USB (universal serial bus) is used. In this two way communication, it is possible to perform control by connecting in parallel from a PC to image display apparatuses connected in parallel.

In Japanese Unexamined Patent Application, First Publication No. 2000-352962, it is proposed to automatically set the image display apparatus number using a communication device. Since this method and operation have been described, description is omitted here. In the second embodiment, in addition to the above mentioned conventional method, the image extraction device 83 is connected to the communication device 81, and the maximum resolution which can be displayed by the image display device 29 of the image display apparatus which is set in the image extraction device 83 is read out by the communication device 81, and this information is transmitted to the image signal generator 11. As a result, the image signal generator 11 recognizes from this information the maximum resolution which can be displayed by the connected image display apparatus 13, and determines the resolution of the image data which is carried on the image frame displayed in the connected image display apparatus 13.

In the above description, the communication device was a two way communication device such as a USB. However communication can be realized even with a simple method using a DDC (display data channel). A DDC is technology generally mounted in recent PCs. By using this DDC technology, the second embodiment can be realized even more easily.

According to the configuration of the second embodiment, the communication device 81 is provided, and the maximum resolution capable of display on the image display device 29 of the image display apparatus which is set in the image extraction device 83 is read out, and this information is transmitted to the image signal generator 11. As a result, the operator of the image display apparatus can set the image display apparatus number for each of the respective image display apparatuses, so that the time for setting the output resolutions which match with this image display apparatus can be omitted. Hence a more agreeable image display apparatus use environment can be provided.

### Third Embodiment

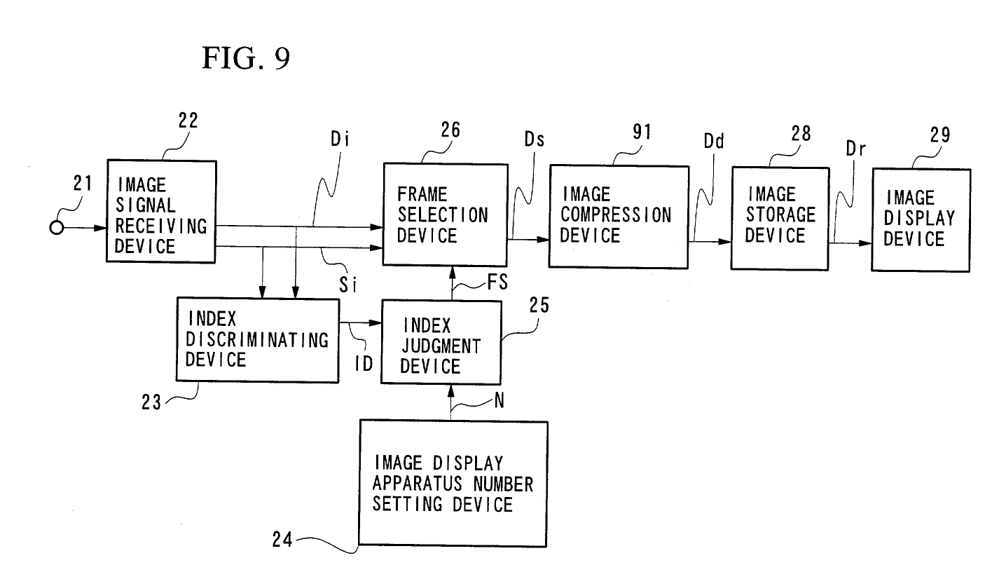

FIG. 9 is a block diagram showing a configuration of an image display apparatus 13 according to a third embodiment of the invention. As shown in FIG. 9, the image display apparatus of the third embodiment comprises; an image signal input terminal 21, an image signal receiving device 22, an index discriminating device 23, an image display apparatus number setting device 24, an index judgment device 25, a frame selection device 26, an image compression device 91, an image storage device 28 and an image display device 29. That is, the image display apparatus of the third embodiment of FIG. 9 differs from the first embodiment of FIG. 2 in that the image compression device 91 is provided instead of the image extraction device 27. Other configuration is similar to that of the first embodiment and hence description thereof is omitted. Dd is the image signal compressed by the image compression device 91.

In the configuration described so far, the image signal output from the image signal generator 11 is appropriately displayed by matching with the maximum resolution which can be displayed on the image display apparatus 13. In contrast, in the third embodiment, the image signal generator 11 generates and outputs an image signal which is matched with the maximum resolution within the image display system. That is, the operation up to the frame selection device 26 is the same as that for the first embodiment of FIG. 2, and is thus omitted. The image signal Ds selected by the frame selection device 26 is input to the image compression device 91. As a result, the image compression device 91 compares the resolution of the input image signal with a previously set maximum resolution which the image display device of the image display apparatus can display, and in the case where this is higher, compresses this to an image which can be suitable for the maximum resolution which can be displayed on the image display apparatus.

At this time, the compression method may be a method where the image data is thinned out to match more simply with the compressibility. However, since in this case the image quality is lowered, an averaging interpolation method using a bilinear method or the like, or an interpolation algorithm which uses a non linear filter such as a higher resolution cubic convolution may also be adopted. The image signal Dd compressed by the image compression device 91 to the maximum resolution which can be displayed by the image display device of the image display apparatus, is output from the image compression device 91 to the image storage device 28. Then the image storage device 28 stores the image signal Dd output from the image compression device 91, and converts the stored image signal into a format which the image display device 29 can display and outputs this. The image display device 29 receives the image signal Dr output from the image storage device 28 and displays this.

According to the configuration of the third embodiment, even though the image display apparatuses connected inside the image display system have different maximum resolutions, an image display apparatus with a lower maximum resolution than that of the image display apparatuses connected inside the image display system, performs display for a screen where this is compressed to the maximum resolution which the image display apparatus can display. Therefore, the common image signal generators no longer need to set the resolution which is output for each of the pages, to match the resolution of the respective image display apparatuses. As a result, the time and effort necessary for resetting the output resolution, or the time etc. required for switching can be saved, enabling construction of a more effective image display system.

### Fourth Embodiment

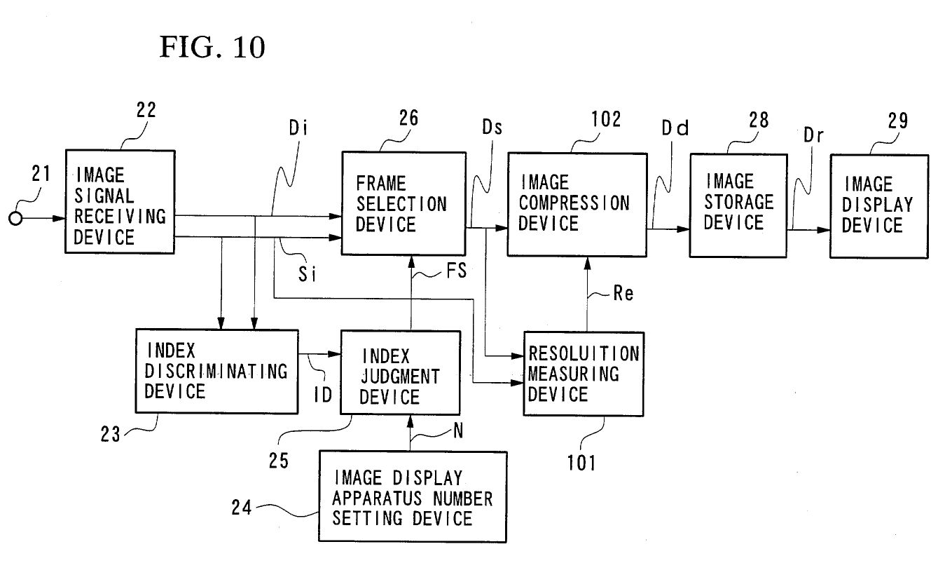

FIG. 10 is a block diagram showing a configuration of an image display apparatus 13 according to a fourth embodiment of the invention. The image display apparatus 13 of the fourth embodiment shown in FIG. 10 is one where a resolution measuring device 101 is added to the image display apparatus 13 of the third embodiment shown in FIG. 9. The image compression device 102 of FIG. 10 has a different signal input and output configuration to the image compression device 91 of the third embodiment shown in FIG. 9, and hence the reference symbol is changed. Furthermore, Re denotes information of a measurement result measured by the resolution measuring device 101, while Dd denotes an image signal compressed by the image compression device 102 and output to the image storage device 28. Other configuration is the same as for the case of FIG. 2 and description thereof is omitted.

In FIG. 10, since the operation of the image display apparatus 13 up until the output from the frame selection device 26 is the same as for that of the first embodiment, description thereof is omitted. As shown in FIG. 10, the image signal Ds output from the frame selection device 26 is input to the image compression device 102 and the resolution measuring device 101. Furthermore, the synchronization signal Si output from the image signal receiving device 22 is also input to the resolution measuring device 101. The resolution measuring device 101 measures the horizontal and vertical resolution of the image signal Ds received at the timing of the input synchronization signal Si, and outputs a measuring result Re to the image compression device 102.

The image compression device 102, based on the measuring result Re received from the resolution measuring device 101, in the case where the measuring result Re is higher than the maximum resolution which can be displayed by the image display device 29 of the image display apparatus, compresses the image so that this becomes a maximum resolution which can be displayed by the image display device 29 of the image display apparatus, and outputs a compressed image signal Dd to the image storage device 28. Then, the image storage device 28 stores the image signal Dd output from the image compression device 91, and converts the stored image signal to a format which can be displayed by the image display device 29, and outputs this. The image display device 29 receives the image signal Dr output from the image storage device 28 and displays this.

As described above, according to the configuration of the fourth embodiment, even though the image display apparatuses connected within the image display system have different maximum resolutions, an image display apparatus for which the maximum resolution is lower than that of the image display apparatuses connected within the image display system automatically compresses the image to the maximum resolution which the image display apparatus can display and displays this image. Consequently, the image signal generator 11 and the image display apparatus 13 no longer need to set the resolution which is output for each of the pages, to match the respective resolutions. As a result, the time and effort necessary for resetting the output resolutions, or the time etc. required for switching screens can be saved, enabling construction of a more effective image display system.

### Fifth Embodiment

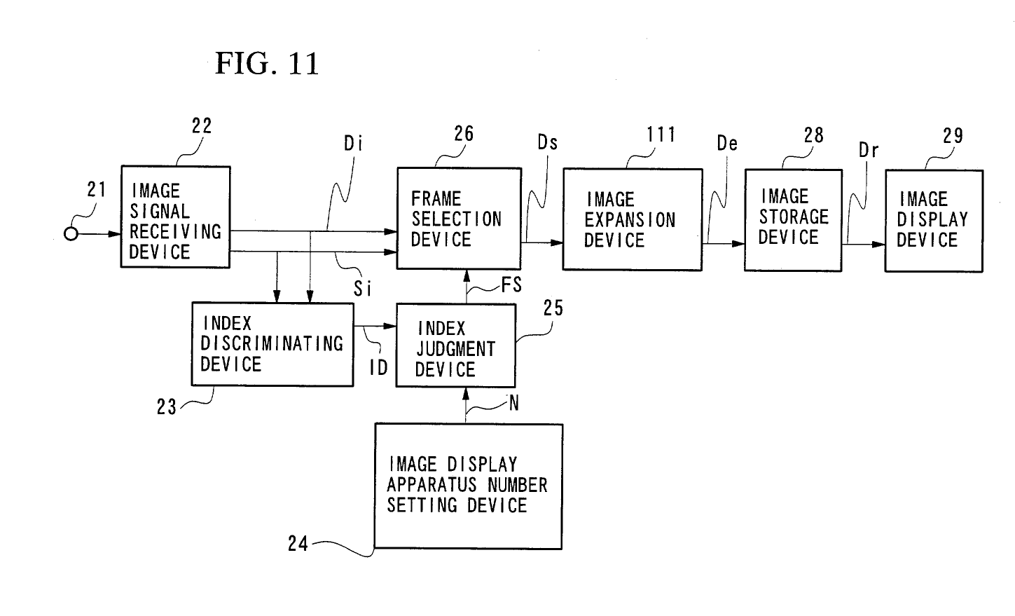

FIG. 11 is a block diagram showing a configuration of an image display apparatus 13 in a fifth embodiment of the present invention. The image display apparatus 13 of the fifth embodiment shown in FIG. 11 is one where the image compression device 91 in the third embodiment shown in FIG. 9 is replaced by an image expansion device 111. De denotes an image signal which has been expanded by the image expansion device 111. Other configuration is as described for FIG. 2 and FIG. 9 and hence repeated description is omitted.

In the third embodiment shown in FIG. 9, the image signal generator 11 had an output resolution matching the maximum resolution which could be displayed on an SXGA image display apparatus 12 connected within the image system, and this was compressed and displayed by the XGA image display apparatus 13 having a maximum resolution which could be displayed on the image display apparatus which did not satisfy the maximum resolution inside the image display system. However, in the fifth embodiment, the image signal is output with the resolution of the image signal output from the image signal generator 11 fixed at the lowest resolution of the individual maximum resolutions which can be displayed on the image display apparatuses connected to the image display system.

Hereunder is a description of the operation in accordance with FIG. 11, of the SXGA image display apparatus 12, from receiving the image signal up until display. Here, up until output from the frame selection device 26 is the same as for the first embodiment, and hence repeated description is omitted. The image signal Ds output from the frame selection device 26 is input to the image expansion device 111. The image expansion device 111 expands the received image signal to a maximum resolution which the image display device 29 of the image display apparatus can display and outputs this. At this time, the expansion method may be a method where the image data is duplicated to match more simply with the expansion ratio. However, since in this case the image quality is degraded, an averaging interpolation method using a bilinear method or the like, or an interpolation algorithm which uses a non linear filter such as a higher resolution cubic convolution may be adopted.

The expanded image signal De is output from the image expansion device 111 and input to the image storage device 28. The image storage device 28 stores the input image signal and converts the stored image signal to a format which the image display device 29 can display and outputs this. The image signal Dr output from the image storage device 28 is input to the image display device 29, and the image display device 29 displays this image signal. In the fifth embodiment, the expansion ratio of the image expansion device 111 is arbitrarily set, however by adding a resolution measuring device as described in the fourth embodiment, then it is also possible to set this automatically. In this case, the expansion ratio, as with the fourth embodiment is obtained from the measurement result and the maximum resolution which can be displayed on the image display device 29.

According to the configuration of the fifth embodiment, even though the plurality of image display apparatuses connected inside the image display system have different maximum resolutions, an image display apparatus for which the maximum resolution which can be displayed on the image display apparatus is higher than the lowest resolution amongst the maximum resolutions of the image display apparatuses connected inside the image display system, is able to expand the image signal and also to display the image. Therefore, the image signal generator 11 no longer needs to set the resolution which is output for each of the pages, to match the respective resolutions. As a result, the time and effort necessary for resetting the output resolutions, or the time etc. required for switching can be saved, enabling construction of a more effective image display system.

### Sixth Embodiment

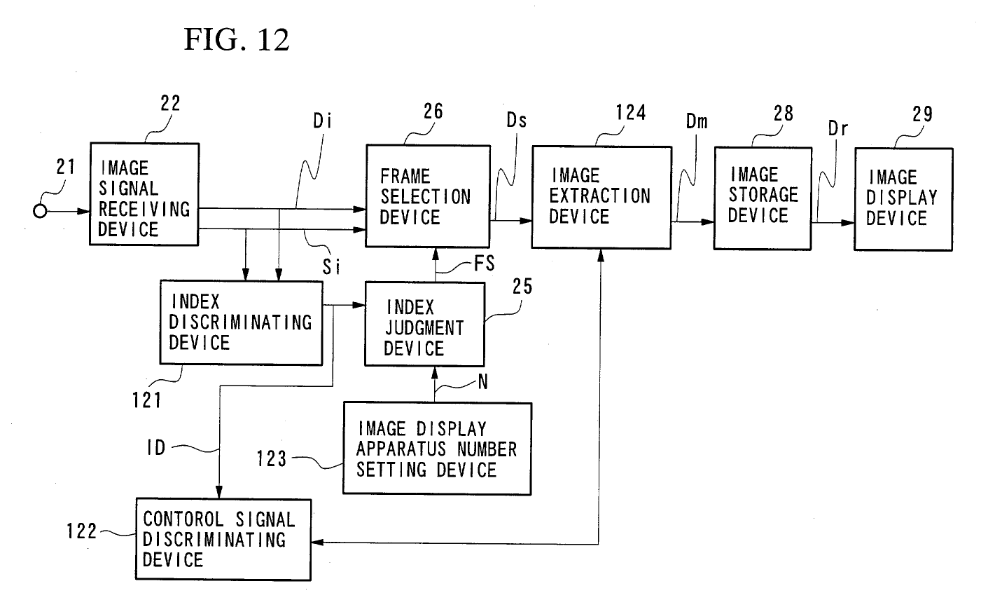

FIG. 12 is a block diagram showing a configuration of an image display apparatus 13 in a sixth embodiment of the present invention. The image display apparatus 13 of the sixth embodiment shown in FIG. 12 is one where a control signal discriminating device 122 is added to the configuration of the first embodiment shown in FIG. 2. An index discriminating device 121, an image display apparatus number setting device 123 and an image extraction device 124 have different signal interchange to the case of FIG. 2 and hence the reference symbols are changed. Other configuration is the same as for the contents described for FIG. 2, and hence repeated description is omitted.

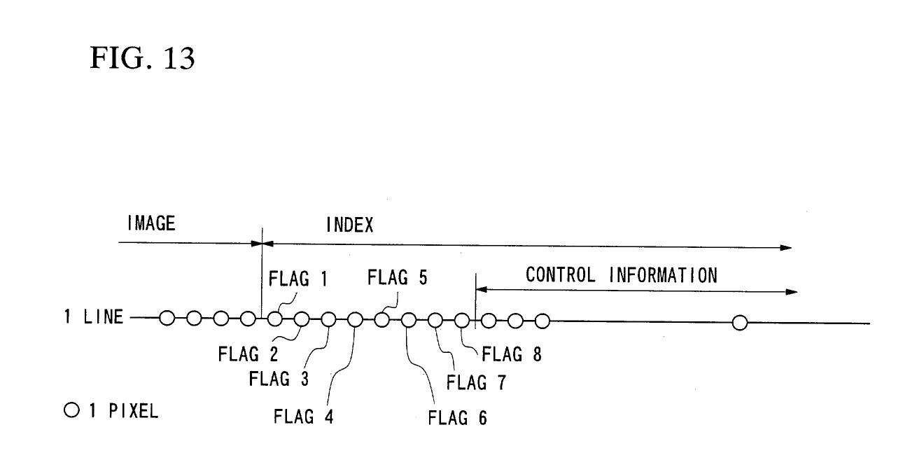

FIG. 13 is a diagram showing by means of flags, a configuration of a transmission index signal in the sixth embodiment. That is, in Japanese Unexamined Patent Application, First Publication No. 2000-352962 being the conventional example, there is proposed a technique for controlling the image display apparatus by adding a control signal to the transmission index. The transmission index showing the configuration for the control signal at this time is that of FIG. 13. In the sixth embodiment, information for the resolution and the image extraction position is added to the control information shown in FIG. 13. In other words, the image signal generator 11 adds the information for the resolution and the position for image extraction, to the output transmission index signal.

Hereunder is a description of the operation in accordance with FIG. 12, of an image display apparatus which receives a composite signal containing the transmission index signal. The composite signal which is input to the image input terminal 21 of the image display apparatuses 12 and 13 is received by the image signal receiving device 22. The image signal receiving device 22, as described in Japanese Unexamined Patent Application, First Publication No. 2000-352962, outputs a synchronization signal Si and a digitized image signal Di. In this case, the transmission index is substituted within the image signal Di and decoded.

The synchronization signal Si and the image signal Di output from the image signal receiving device 22 are input to the frame selection device 26 and the index discriminating device 121. The index discriminating device 121 computes the position within the image signal, of the transmission index signal which is constituted by the light and shade of the pixel shown in FIG. 6, with the synchronization signal Si as a reference for the timing (datum reference on the time axis), and extracts the received transmission index signal. The transmission index signal extracted by the index discriminating device 121 is binarized based on a previously set threshold value.

The index ID output from the index discriminating device 121 is output to the index judgment device 25 and the control signal discriminating device 122. The control signal discriminating device 122 extracts a control signal containing information of the image extraction position and resolution from the input index ID, and outputs this information to the image extraction device 124.

On the other hand, the image display apparatus number setting device 123 outputs an image display apparatus number N previously set for the image display apparatus, to the index judgment device 25. The index judgment device 25, based on the determined index ID and the image display apparatus number N, outputs a frame selection signal FS to the frame selection device 26. The frame selection device 26, based on the frame selection signal FS output by the index judgment device 25, selects a designated frame from the input image signal Di. Here, since the transmission index signal is substituted for one part of the image period, then the actually selected frame is a frame one frame later.

The image signal Ds selected by the frame selection device 26 is output to the image extraction device 124. The image extraction device 124 extracts the image data from the image signal Ds selected by the frame selection device 26, based on the information for the resolution and image extraction position input from the control signal discriminating device 122. The image extraction device 124 outputs the extracted image signal Dm to the image storage device 28. The image storage device 28 receives and stores the image signal Dm output from the image extraction device 124. Furthermore, the image storage device 28 reads out the stored image data and converts this to a format which can be displayed by the image display device 29 and outputs this. The image display device 29 receives and displays the image signal Dr output from the image storage device 28.

According to the configuration of the sixth embodiment, information can be received and transferred between the image signal generator 11 and the image display apparatus 13 without providing a special communication device or connection cable. Moreover, since this information can include information of the image extraction position, the position for the image to be displayed can be automatically set. As a result, even in the case where there are image display apparatuses with different resolutions within the image display system, the image display apparatus can be used without the operator being aware of this.

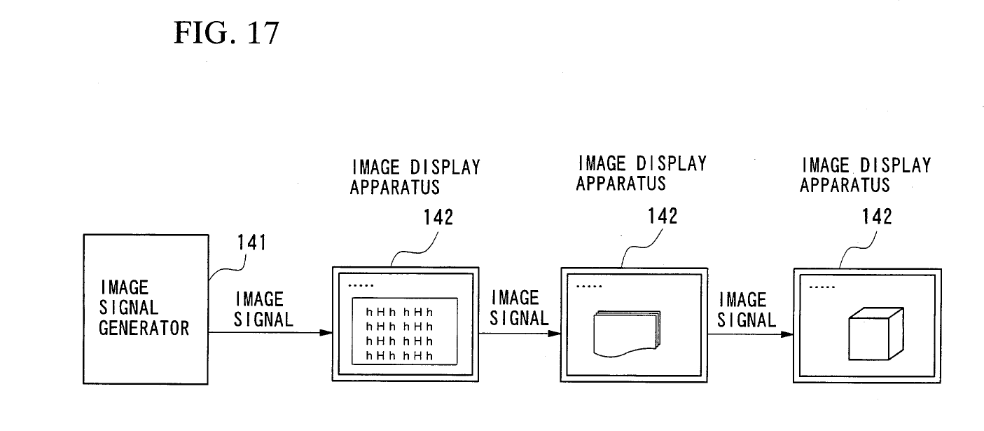

The above described embodiment is one example for describing this invention, however this invention is not limited to the above described embodiment, and various modifications are possible within the scope of the gist of the invention. In the above mentioned embodiment, the description was for where a plurality of image display apparatuses are connected in parallel to the image signal generator, as shown in FIG. 1. However, as also shown for the conventional example, by connecting the image display apparatuses in series as shown in FIG. 17, the same affect can also be obtained.

1. An image display apparatus for receiving an image signal having a predetermined format and displaying said image signal, comprising:
an image signal receiving section which receives a composite image signal containing an image signal comprising a plurality of image frames, a synchronization signal corresponding to said image signal, and a transmission index signal substituted for one part of said image signal, and outputs said image signal and said synchronization signal;
an image frame selection section which selects image frames to be displayed on the image display apparatus from said plurality of image frames, based on the transmission index signal output from said image signal receiving section, and extracts and outputs image signals of a resolution which can be displayed on the image display apparatus from the selected image signals; and
an image display section which displays an image signal which is output from said image frame selection section.

2. An image display apparatus according to claim 1, wherein said image frame selection section comprises:
an index discriminating device which discriminates a transmission index signal contained in either of an image display period or an image non-display period in an image frame, based on the image signal and the synchronization signal output from said image signal receiving section;
an image display apparatus number setting device which outputs an image display apparatus number set with respect to the image display apparatus;
an index judgment device which outputs a frame selection signal for selecting an image frame contained in an image signal, based on an index signal output by said index discriminating device and an image display apparatus number of the image display apparatus output by said image display apparatus number setting device;
a frame selection device which selects an image frame contained in said image signal corresponding to a frame selection signal output from said index judgment device;
an image extraction device which extracts an image signal corresponding to the image frame output from said frame selection device, as data for the maximum resolution amount which can be displayed in the image display section of the image display apparatus; and
an image storage device which stores image signals which said image extraction device has extracted and output.

3. An image display apparatus according to claim 1, wherein said image frame selection section comprises:
an index discriminating device which discriminates a transmission index signal contained in either of an image display period or an image non-display period in an image frame, based on the image signal and the synchronization signal output from said image signal receiving section;
an image display apparatus number setting device which outputs an image display apparatus number set with respect to the image display apparatus;
an index judgment device which outputs a frame selection signal for selecting said image frame contained in an image signal, based on an index signal output by said index discriminating device and an image display apparatus number of the image display apparatus output by said image display apparatus number setting device;
a frame selection device which selects an image frame contained in said image signal corresponding to a frame selection signal output from said index judgment device;
an image compression device which compresses signals so that an image signal corresponding to an image frame output from said frame selection device can be the maximum resolution which the image display section of the image display apparatus can display, and
an image storage device which stores image signals which said image compression device has compressed and output.

4. An image display apparatus according to claim 1, wherein said image frame selection section comprises:
an index discriminating device which discriminates a transmission index signal contained in either of an image display period or an image non-display period in said image frame, based on the image signal and the synchronization signal output from said image signal receiving section;
an image display apparatus number setting device which outputs an image display apparatus number set with respect to the image display apparatus;
an index judgment device which outputs a frame selection signal for selecting said image frame contained in an image signal, based on an index signal output by said index discriminating device and an image display apparatus number of the image display apparatus output by said image display apparatus number setting device;
a frame selection device which selects an image frame contained in said image signal corresponding to a frame selection signal output from said index judgment device;
an image expansion device which expands signals so that an image signal corresponding to an image frame output from said frame selection device can be the maximum resolution which the image display section of the image display apparatus can display, and
an image storage device which stores image signals which said image expansion device has expanded and output.

5. An image display apparatus according to claim 2, wherein said image frame selection section further comprises a resolution measuring device which measures a resolution of a received image signal.

6. An image display apparatus according to claim 3, wherein said image frame selection section further comprises a resolution measuring device which measures a resolution of a received image signal.

7. An image display apparatus according to claim 4, wherein said image frame selection section further comprises a resolution measuring device which measures a resolution of a received image signal.

8. An image display apparatus according to claim 2, wherein said image frame selection section further comprises a communication device which communicatively connects said image display apparatus number setting device and said image extraction device.

9. An image display apparatus according to claim 3, wherein said image frame selection section further comprises a communication device which communicatively connects said image display apparatus number setting device and said image compression device.

10. An image display apparatus according to claim 4, wherein said image frame selection section further comprises a communication device which communicatively connects said image display apparatus number setting device and said image expansion device.

11. An image display apparatus according to claim 5, wherein said image frame selection section further comprises a communication device which communicatively connects said image display apparatus number setting device and said image extraction device.

12. An image display apparatus according to claim 6, wherein said image frame selection section further comprises a communication device which communicatively connects said image display apparatus number setting device and said image compression device.

13. An image display apparatus according to claim 7, wherein said image frame selection section further comprises a communication device which communicatively connects said image display apparatus number setting device and said image expansion device.

14. A control method for an image display apparatus for receiving an image signal having a predetermined format and displaying said image signal on an image display apparatus, comprising the steps of;
controlling an extraction position of the image signal based on a control signal contained in a transmission index signal, and
displaying a desired image on said image display apparatus.
